(19) United States
(12) Patent Application Publication
(10) Pub. No.: US 2014/0141318 A1
(43) Pub. Date: May 22, 2014

(54) LITHIUM-ION BATTERY AND LITHIUM-ION BATTERY ELECTRODE STRUCTURE WITH DOPANTS

(71) Applicant: National Taiwan University, Taipei (TW)

(72) Inventors: Si-Chen Lee, Taipei (TW); Jhao-Ru Huang, Taichung City (TW); Hsu-Kai Chang, Taipei (TW); Nae-Lih Wu, Taipei (TW); Yu-Chan Yen, Taipei City (TW); Chun-Chieh Lin, Hsinchu City (TW)

(21) Appl. No.: 13/919,871

(22) Filed: Jun. 17, 2013

(30) Foreign Application Priority Data
Nov. 21, 2012 (TW) 101143519

(51) Int. Cl. H01M 4/38

(52) U.S. Cl. CPC H01M 4/386
USPC 429/177; 429/233; 429/218.1; 429/245

(57) ABSTRACT

A lithium-ion battery and a lithium-ion battery electrode structure are disclosed. The lithium-ion battery electrode structure comprises a metal foil and a semiconductor nanowire matrix. The semiconductor nanowire matrix is disposed on the metal foil, and is doped with dopants.

### CROSS-REFERENCE TO RELATED APPLICATION(S)

This application claims priority to Taiwan Patent Application No. 101143519, filed on Nov. 21, 2012, the disclosure of which is hereby incorporated by reference herein its entirety.

### BACKGROUND

1. Field

The present disclosure relates to a lithium-ion battery, more particularly, to a lithium-ion battery electrode structure.

2. Description of the Related Art

Lithium-ion battery is the secondary battery (or rechargeable battery) with the highest energy density but without the battery memory effect. Since the price of the lithium-ion battery was high in its early days, the lithium-ion battery may be applied to the high-priced and small-sized electronic products, such as mobile phones, notebook computers, and medical equipment. However, because of technology maturity and price decreasing in recent years, Li-ion batteries can be used in wider application range, such as for cars, so that they would be the most suitable candidate for secondary batteries. Generally, a commercial lithium-ion battery adopts graphite as an anode material. However, the theoretical specific capacity of graphite is 372 mAh/g during charging/discharging processes. Further, dendrite formation may occur in lithium-ion batteries when using pure Li metal as the electrode material. Large dendrites can cause an internal short circuit, resulting in battery failure and possible fire.

Currently, silicon may be used as the anode material for lithium-ion batteries, which has lower discharge potential and higher theoretical specific capacity (4200 mAh/g). In other words, silicon can hold 10 times more Li ions than graphite. However, Si anodes may experience large volume changes (400%) during charging/discharging processes, which can induce fracture of Si film or Si particles from substrates. To relieve the large volume expansion and maintain continuous electrical connection between fractured Si particles, carbon materials should be dispersed in a Si matrix. However, the addition of carbon atoms should exceed 50 wt % to reduce capacity loss.

Although anode materials using Si nanowires (SiNWs) may relieve the fracture of Si film, SiNWs have large irreversible capacity in the first cycle. Furthermore, their capacity decreases rapidly with increasing cycle numbers.

With respect to this issue, it is desirable to develop new battery electrodes that can achieve high capacity while maintaining good cycle life.

### SUMMARY

The present application describes an electrode structure for a lithium-ion battery. By providing high dopant concentrations without conductive binders or fillers, the electrical conductivity and the electron concentrations of semiconductor nanowires can be highly enhanced.

In one embodiment, a lithium-ion battery electrode structure is provided. The electrode structure comprises a metal foil and a semiconductor nanowire matrix. The semiconductor nanowire matrix may have individual diameters around 10˜500 nm and is formed on the metal foil. The semiconductor nanowire matrix is doped with dopants.

In other embodiment, a lithium-ion battery is provided. The lithium-ion battery comprises a first cover, a second cover, an anode, a cathode, a separator, and an electrolyte. The second cover is opposite to the first cover to form an accommodation space. The anode is disposed in the accommodation space and close to the first cover. The cathode is disposed in the accommodation space and close to the second cover. The separator is disposed in the accommodation and between the anode and the cathode. The electrolyte is filled in the accommodation space. The lithium-ion battery electrode structure comprises a metal foil and a semiconductor nanowire matrix. The semiconductor nanowire matrix is formed on the metal foil. The semiconductor nanowire matrix is doped with dopants.

Overall, the present disclosure describes a lithium-ion battery electrode structure having abilities of improving nanowire conductivity and increasing electron concentrations. Therefore, the performance of the lithium-ion battery can be highly improved. Additionally, since the semiconductor nanowire matrix is in one dimension, the surface area thereof is large, which is favor of increasing the speed of Li ion insertion/extraction, and releasing the stress of volume expansion. Therefore, the lithium-ion battery electrode structure with semiconductor nanowire matrix has better capacity retention.

The foregoing is a summary of the disclosed embodiments and shall not be construed as limiting the scope of the claims. The operations and devices disclosed herein may be implemented in a number of ways, and such changes and modifications may be made without departing from this disclosure and its broader aspects. Other aspects, inventive features, and advantages of the disclosure, as defined solely by the claims, are described in the non-limiting detailed description set forth below.

### BRIEF DESCRIPTION OF THE DRAWINGS

FIG. 1A is a schematic view illustrating a lithium-ion battery electrode structure in accordance with one embodiment of the present disclosure.

FIG. 1B is a schematic view illustrating a lithium-ion battery in accordance with one embodiment of the present disclosure.

FIG. 2 is a schematic view illustrating a manufacturing process of a lithium-ion battery electrode structure in accordance with one embodiment of the present disclosure.

FIG. 3 is a schematic view illustrating a manufacturing process of a lithium-ion battery electrode structure in accordance with one embodiment of the present disclosure.

FIG. 4A is a scanning electron microscopy image of silicon nanowire electrode structures in accordance with one embodiment of the present disclosure.

FIG. 4B is a scanning electron microscopy image of silicon-germanium nanowire electrode structures in accordance with one embodiment of the present disclosure.

FIG. 5(a) illustrates characteristic experimental curves of specific capacity versus cycle number of the doped and undoped SiNW cells in accordance with one embodiment of the present disclosure.

FIG. 5(b) illustrates characteristic experimental curves of columbic efficiency versus cycle number of the doped and undoped SiNW cells in accordance with one embodiment of the present disclosure.

FIG. 6(a) illustrates characteristic experimental curves of specific capacity versus cycle number of the doped and undoped SiNW cells in accordance with one embodiment of the present disclosure.

FIG. 6(b) illustrates characteristic experimental curves of columbic efficiency versus cycle number of the doped and undoped SiNW cells in accordance with one embodiment of the present disclosure.

FIG. 7A illustrates characteristic experimental curves of cycle life for the doped SiGeNW cell and undoped SiNW cell in accordance with one embodiment of the present disclosure.

FIG. 7B illustrates experimental rate performance of doped SiGeNW cell and undoped SiNW cell in accordance with one embodiment of the present disclosure.

### DETAILED DESCRIPTION OF EMBODIMENTS

The following description is made for the purpose of illustrating the general principles of the disclosure and should not be taken in a limiting sense. The scope of the disclosure is best determined by reference to the appended claims. References will be made in detail to the present embodiments, examples of which are illustrated in the accompanying drawings. Wherever possible, the same reference numbers are used in the drawings and the description to refer to the same or like parts.

In the drawings, the shape and thickness of one embodiment may be exaggerated for clarity and convenience. This description will be directed in particular to elements forming part of, or cooperating more directly with, apparatus in accordance with the present disclosure. It is to be understood that elements not specifically shown or described may take various forms well known to those skilled in the art. Further, when a layer is referred to as being on another layer or “on” a substrate, it may be directly on the other layer or on the substrate, or intervening layers may also be present.

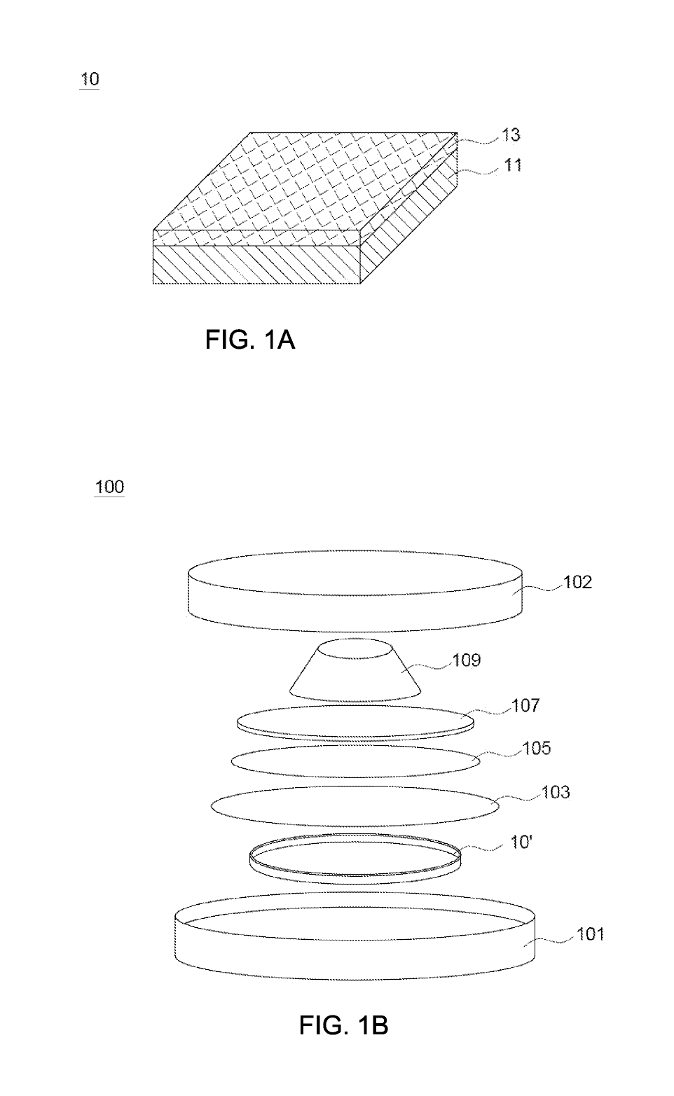

Refer to FIGS. 1A and 1B, in which FIG. 1A is a schematic view illustrating a lithium-ion battery electrode structure in accordance with one embodiment of the present disclosure, and FIG. 1B is a schematic view illustrating a lithium-ion battery in accordance with one embodiment of the present disclosure. As shown in FIGS. 1A and 1B, the lithium-ion battery electrode structure 10 may be the anode or the cathode structure of the lithium-ion battery 100. The lithium-ion battery 100 commonly has two covers including a first cover 101 and a second cover 102, besides an anode 10′, a separator 103, a cathode 105, a protective layer 107, a spring layer 109, and an electrolyte (not shown) are disposed between the two covers 101, 102 sequentially. In this embodiment, the lithium-ion battery electrode structure 10 is applied for the anode 10′, and the cathode 105 adopts the lithium foil.

In one embodiment, the two covers 101, 102 of the lithium-ion battery 100 are opposite from each other to form an accommodation space (unmarked). The anode 10′ is disposed in the accommodation space and is close to the first cover 101. The cathode 105 is disposed in the accommodation space and is close to the second cover 102. The separator 103 is disposed in the accommodation space and is between the anode 10′ and the cathode 105. The protective layer 107 is disposed in the accommodation space and is between the cathode 105 and the second cover 102. The spring layer 109 is disposed in the accommodation space and is between the protective layer 107 and the second cover 102. The electrolyte is disposed in the accommodation space, preferably filling that space. In one embodiment, the lithium-ion battery electrode structure 10 comprises a metal foil 11 and a semiconductor nanowire matrix 13, in which the semiconductor nanowire matrix 13 is formed on the metal foil 11 through a chemical vapor deposition (CVD) process and doped with high concentration dopants through, for example but not limited to, in-situ, ion implantation or diffusion processes.

In one embodiment, the metal foil 11 may comprise titanium (Ti), cobalt (Co), nickel (Ni), aluminum (Al), copper (Cu), molybdenum (Mo), platinum (Pt), tungsten (W), gold (Au), silver (Ag), stainless steel, or an alloy of these metals. The semiconductor nanowire matrix 13 may have individual diameters in the range of about 10 to about 500 nm and may be a SiNW matrix comprising a plurality of SiNWs, or a silicon-germanium nanowire (SiGeNW) matrix comprising a plurality of SiGeNWs. In one embodiment, the plurality of SiNWs or SiGeNWs could have individual diameters less than about 100 nm. The dopants may be n-type or p-type elements, such as phosphorous (P), arsenic (As), antimony (Sb), boron (B), aluminum (Al), gallium (Ga), or indium (In). The concentration of the dopants may be, for example but not limited to, greater than about 10¹⁹ cm⁻³ (e.g., 10¹⁹ atoms per cubic centimeter).

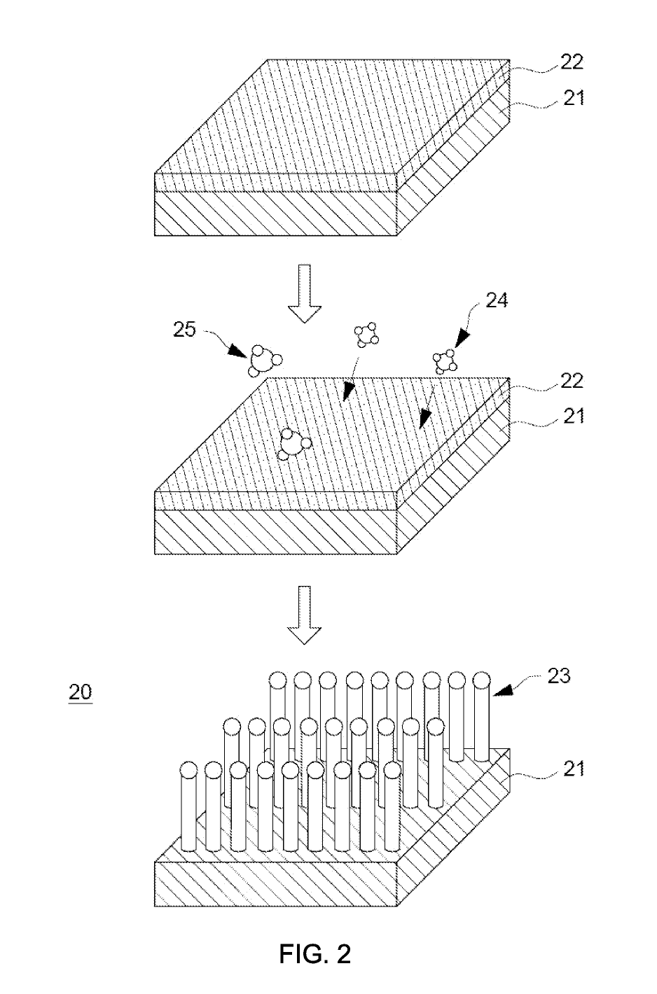

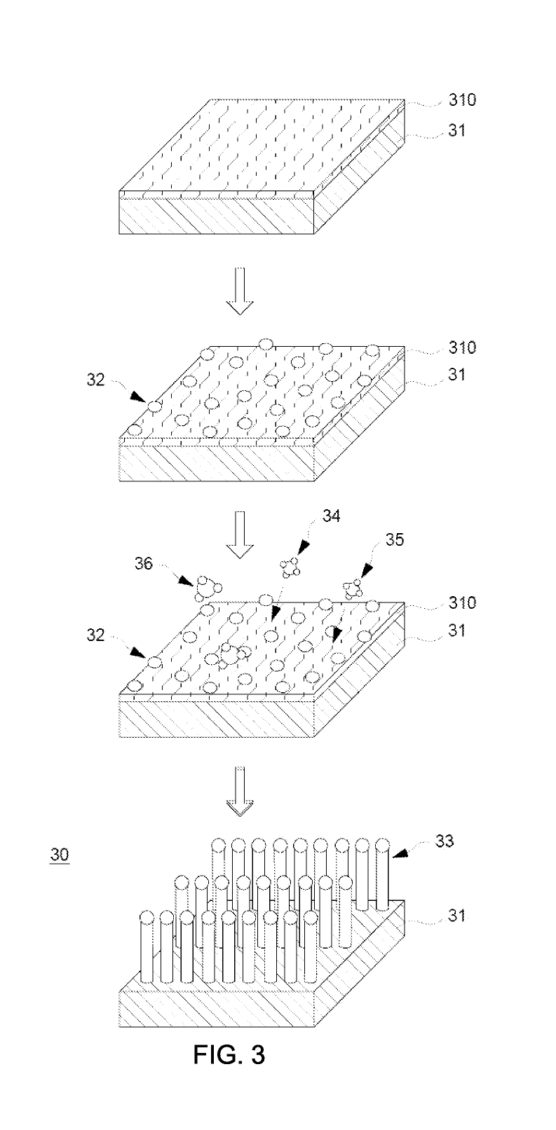

To describe the Li-ion battery electrode structure 10 in more detail, please refer to FIGS. 2 and 3. FIG. 2 is a schematic view illustrating a manufacturing process of a Li-ion battery electrode structure in accordance with one embodiment of the present disclosure. FIG. 3 is a schematic view illustrating a manufacturing process of a Li-ion battery electrode structure in accordance with one embodiment of the present disclosure. As shown in FIG. 2, the Li-ion battery anode 20 takes the SiNW matrix with high concentration phosphorous dopants in consideration. The manufacturing process of the Li-ion battery electrode structure 20 contains the following steps: providing a metal foil 21 as a substrate, which could comprise titanium (Ti), cobalt (Co), nickel (Ni), aluminum (Al), copper (Cu), molybdenum (Mo), platinum (Pt), tungsten (W), gold (Au), silver (Ag), stainless steel or an alloy of them; then, coating a metal film 22 with catalysts for growing SiNWs, in which the coating process may comprises thermal evaporation or sputtering, and the metal film 22 could comprise Au, Pt, Ag, iron (Fe), Al, Cu, Co, or Ni, whose thickness is, for example but not limited to, a range of about 1-100 nm.

The manufacturing process may comprise arranging the metal film 22 coated metal foil 21 in a chemical vapor deposition (CVD) system. Then, a first reactive gas 24 is introduced in the chamber to form undoped nanowire matrix. The first reactive gas 24 may be in the range of about 5-20% silane (SiH₄) in nitrogen (N₂) gas, and the flow rate may be in the range of about 700-850 sccm. In one embodiment, the system may be, for example but not limited to, a low-pressure CVD system, in which the operating pressure is in the range of about 20-50 Torr. The operating time may be in the range of about 30-35 minutes, and the operating temperature may be in the range of about 470-550° C.

After introducing the first reactive gas 24, a second reactive gas 25 is introduced in the CVD system as the doping gas to form the doped SiNW matrix 23. In one embodiment, the second reactive gas 25 may be in the range of about 1-3% phosphine (PH₃) in nitrogen (N₂) gas, and the flow rate may be in the range of about 5-50 sccm to form the SiNW matrix 23 with n-type dopants.

In one embodiment, the first reactive gas 24 and the second reactive gas 25 could be applied through in-situ, ion implantation, or thermal diffusion processes to form large area SiNW arrays 23 with n-type dopants.

In other embodiment, the SiNW matrix 23 with p-type dopants could be formed by a similar method. The difference between them is the second reactive gas 25 is replaced by diborane (B₂H₆) in hydrogen (H₂) gas in the range of about 15-25 ppm. The flow rate of the second reactive gas 25 is in the range of about 40-60 sccm to form the SiNW matrix with p-type dopants.

As shown in FIG. 3, the Li-ion battery anode 30 takes the SiGeNW matrix with high concentration n-type dopants in consideration. The process of manufacturing the Li-ion battery anode 30 is similar with that of the anode 20. The difference between them is the reactive gas in the CVD system includes silane (SiH₄) 34, germane (GeH₄) 35, and phosphine (PH₃) 36, and their flow rates are in the range of about 400-1000 sccm, 24-80 sccm, and 10-50 sccm, respectively. The operating temperature of the CVD system is in the range of about 300-400° C., and the operating pressure of the CVD system is in the range of about 20-40 Torr. The reactive gas may be applied through in-situ process to form large area of n-type SiGeNW arrays 33 on the surface of the metal foil 31.

In another embodiment, the metal film could be replaced by metal particles via the following steps: coating an adhesive layer 310 on the metal foil 31, and then depositing (e.g., dripping, sputtering) a layer of metal particles 32 on the adhesive layer 310. In one embodiment, the adhesive layer 310 may comprise, but is not limited to, poly-L-lysine. The metal particles 22 may comprise Au, Pt, Ag, Fe, Al, Cu, Co, or Ni with diameters in the range of about 10-50 nm.

In another embodiment, the process of the SiGeNW matrix with p-type dopants is similar to that of the SiGeNW array 33 with n-type dopants. The difference between them is one of the reactive gas, PH₃ 36, is replaced by diborane (B₂H₆) in H₂, whose flow rate may be in the range of about 40-60 sccm to form the SiGeNW matrix with p-type dopants.

More specifically, anode materials utilizing doped SiNWs or SiGeNWs could improve their conductivity and electron concentrations without adding conductive binders or fillers.

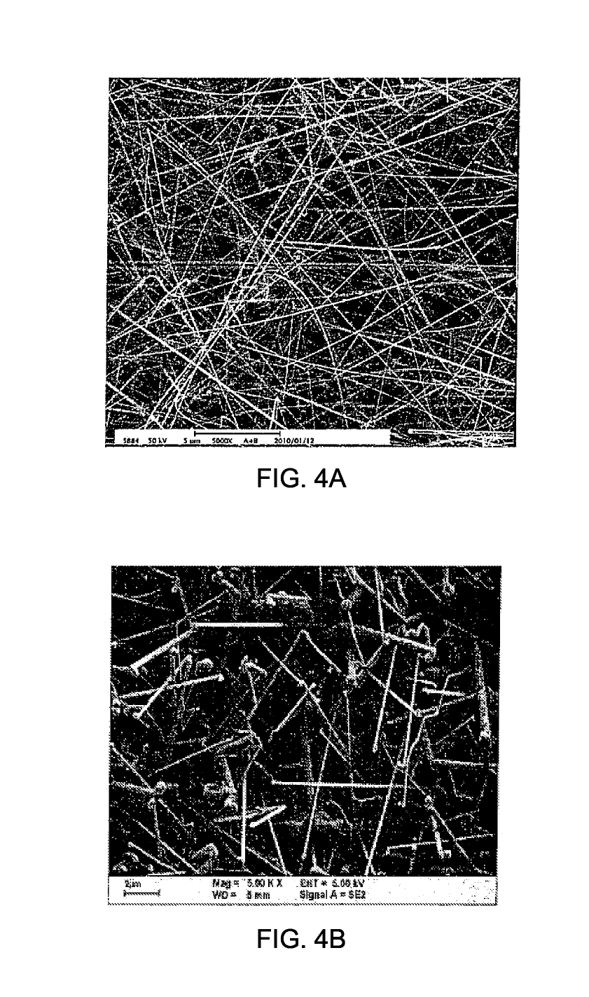

FIG. 4A shows a scanning electron microscopy image of the SiNW matrix as the Li-ion battery electrode structure in accordance with one embodiment of the present disclosure. FIG. 4B shows a scanning electron microscopy image of the SiGeNW matrix as the Li-ion battery electrode structure in accordance with another embodiment of the present disclosure.

FIG. 5(A) illustrates characteristic experimental curves of specific capacity versus cycle number of the doped and undoped SiNW cells under low charging current 0.2 C in accordance with one embodiment of the present disclosure. FIG. 5(B) illustrates characteristic experimental curves of columbic efficiency versus cycle number of the doped and undoped SiNW cells under low charging current 0.2 C in accordance with one embodiment of the present disclosure. FIG. 5(a) reveals that the specific capacity of the doped SiNWs is greater than that of the undoped ones. FIG. 5(b) reveals that the columbic efficiency of the doped SiNWs is greater than that of the undoped ones.

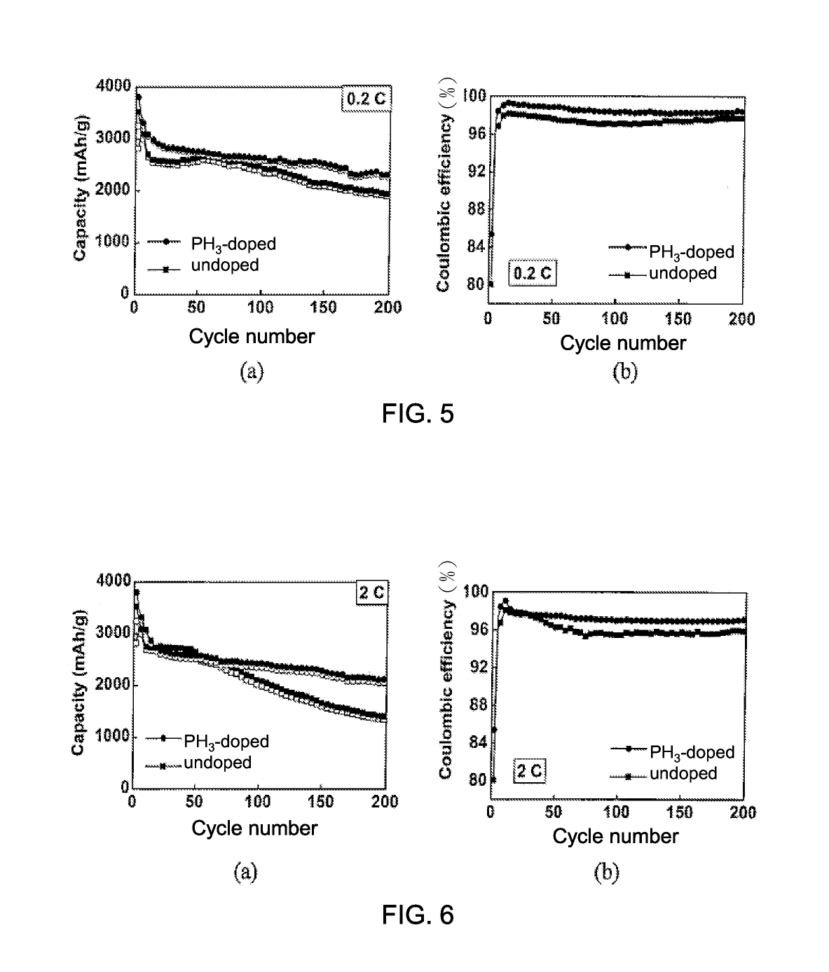

FIG. 6(A) illustrates characteristic experimental curves of specific capacity versus cycle number of the doped and undoped SiNW cells under high charging current 2 C in accordance with one embodiment of the present disclosure. FIG. 6(B) illustrates characteristic experimental curves of columbic efficiency versus cycle number of the doped and undoped SiNW cells under high charging current 2 C in accordance with one embodiment of the present disclosure. FIG. 6(a) reveals that the specific capacity of the doped SiNWs is greater than that of the undoped ones. FIG. 6(b) reveals that the columbic efficiency of the doped SiNWs is greater than that of the undoped ones.

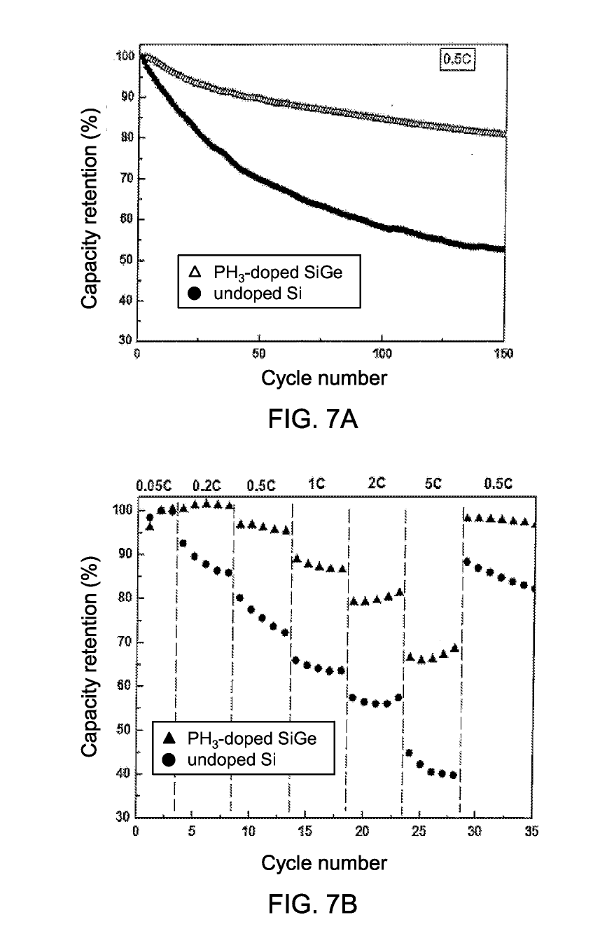

FIG. 7A illustrates the cycle life for doped SiGeNW cell and undoped SiNW cell under low charging current 0.5 C in accordance with one embodiment of the present disclosure. FIG. 7A reveals that the capacity retention of the doped SiGeNW electrode is better than that of the undoped SiNW electrode.

FIG. 7B demonstrates the rate performance for the doped SiGeNW cell and undoped SiNW cell under different discharging rate in accordance with one embodiment of the present disclosure. FIG. 7B reveals that the capacity retention of the doped SiGeNW electrode is better than that of the undoped SiNW electrode. In particular, the doped SiGeNW electrode has excellent capacity retention under 2 C and 5 C.

The nanowire-based electrode structure has at least the abilities of reducing the interaction energy between Li ion and nanowires and providing good electrical connection by doping high concentration dopants Accordingly, the doped SiNWs (SiGeNWs) electrode could maintain the capacity retention and structure stability for lithium-ion batteries so as to achieve long cycle life.

Realizations in accordance with the present disclosure have been described in the context of individual embodiments. These embodiments are meant to be illustrative and not limiting. Many variations, modifications, additions, and improvements are possible. Accordingly, plural instances may be provided for components described herein as a single instance. Structures and functionality presented as discrete components in the exemplary configurations may be implemented as a combined structure or component. These and other variations, modifications, additions, and improvements may fall within the scope of the disclosure as defined in the claims that follow.

What is claimed is:

1. A lithium-ion battery electrode structure, comprising:
a metal foil; and
a semiconductor nanowire matrix comprising nanowires having diameters in the range of about 10 nm to about 500 nm formed on the metal foil;
wherein the semiconductor nanowire matrix is doped with dopants.

2. The lithium-ion battery electrode structure according to claim 1, wherein the semiconductor nanowire matrix comprises a plurality of silicon (Si) nanowires.

3. The lithium-ion battery electrode structure according to claim 1, wherein the semiconductor nanowire matrix comprises a plurality of silicon-germanium (SiGe) nanowires.

4. The lithium-ion battery electrode structure according to claim 2, wherein the dopants are selected from the group consisting of phosphorous (P), arsenic (As), and antimony (Sb).

5. The lithium-ion battery electrode structure according to claim 2, wherein the dopants are selected from the group consisting of boron (B), aluminum (Al), gallium (Ga), and indium (In).

6. The lithium-ion battery electrode structure according to claim 1, wherein the semiconductor nanowire matrix comprises a plurality of silicon (Si) nanowires and silicon-germanium (SiGe) nanowires.

7. The lithium-ion battery electrode structure according to claim 6, wherein the dopants comprise n-type elements.

8. The lithium-ion battery electrode structure according to claim 7, wherein the n-type dopant is selected from the group consisting of phosphorous (P), arsenic (As), and antimony (Sb).

9. The lithium-ion battery electrode structure according to claim 6, wherein the dopants comprise p-type elements.

10. The lithium-ion battery electrode structure according to claim 9, wherein the p-type dopant is selected from the group consisting of boron (B), aluminum (Al), gallium (Ga), and indium (In).

11. The lithium-ion battery electrode structure according to claim 1, wherein the metal foil comprises a metal selected from the group consisting of titanium (Ti), cobalt (Co), nickel (Ni), aluminum (Al), copper (Cu), molybdenum (Mo), platinum (Pt), tungsten (W), gold (Au), silver (Ag), and stainless steel.

12. The lithium-ion battery electrode structure according to claim 11, wherein the metal foil comprises an alloy formed from metals selected from the group consisting of titanium (Ti), cobalt (Co), nickel (Ni), aluminum (Al), copper (Cu), molybdenum (Mo), platinum (Pt), tungsten (W), gold (Au), silver (Ag), and stainless steel.

13. The lithium-ion battery electrode structure according to claim 2, wherein the dopant concentration is greater than about 10¹⁹ cm⁻³.

14. A lithium-ion battery, comprising:
a first cover;
a second cover opposite to the first cover to form an accommodation space;
an anode disposed in the accommodation space and close to the first cover;
a cathode disposed in the accommodation space and close to the second cover;
a separator, disposed in the accommodation space and between the anode and the cathode; and
an electrolyte disposed in the accommodation space;
wherein the anode comprises:
a metal foil; and
a semiconductor nanowire matrix formed on the metal foil;
wherein the semiconductor nanowire matrix is doped with dopants.

15. The battery according to claim 14, further comprising a protective layer disposed in the accommodation space and between the cathode and the second cover.

16. The battery according to claim 15, further comprising a spring layer disposed in the accommodation space and between the protective layer and the second cover.

17. The battery according to claim 14, wherein the semiconductor nanowire matrix comprises a plurality of silicon (Si) nanowires.

18. The battery according to claim 14, wherein the semiconductor nanowire matrix comprises a plurality of silicon-germanium (SiGe) nanowires.

19. The battery according to claim 14, wherein the semiconductor nanowire matrix comprises a plurality of silicon (Si) nanowires and a plurality of silicon-germanium (SiGe) nanowires.

20. The battery according to claim 19, wherein the dopants comprise n-type elements.

21. The battery according to claim 20, wherein the n-type dopant is selected from the group consisting of phosphorous (P), arsenic (As), and antimony (Sb).

22. The battery according to claim 14, wherein the dopants comprise p-type elements.

23. The battery according to claim 22, wherein the p-type dopant is selected from the group consisting of boron (B), aluminum (Al), gallium (Ga), and indium (In).

24. The battery according to claim 14, wherein the metal foil comprises a metal selected from the group consisting of titanium (Ti), cobalt (Co), nickel (Ni), aluminum (Al), copper (Cu), molybdenum (Mo), platinum (Pt), tungsten (W), gold (Au), silver (Ag), and stainless steel.

25. The battery according to claim 14, wherein the metal foil comprises an alloy formed from metals selected from the group consisting of titanium (Ti), cobalt (Co), nickel (Ni), aluminum (Al), copper (Cu), molybdenum (Mo), platinum (Pt), tungsten (W), gold (Au), silver (Ag), and stainless steel.

26. The battery according to claim 14, wherein the dopant concentration is greater than about 10¹⁹ cm⁻³.

27. The battery according to claim 17, wherein the plurality of nanowires have individual diameters less than about 100 nm.
